(19) United States
(12) Patent Application Publication
(10) Pub. No.: US 2006/0232178 A1
(43) Pub. Date: Oct. 19, 2006

(54) Reflector high-pressure discharge lamp

(75) Inventors: Carsten Setzer, Taipei (TW); Kai Wolter, Berlin (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHLAMPEN MBH, MUNCHEN (DE)

(21) Appl. No.: 11/404,037

(22) Filed: Apr. 14, 2006

(30) Foreign Application Priority Data
Apr. 15, 2005 (DE) 102005017505.8

(51) Int. Cl. H01K 1/26; H01K 1/30; H01J 61/40; H01J 5/16

(52) U.S. Cl. 313/113

(57) ABSTRACT

In the reflector high-pressure discharge lamp, including a gastight discharge vessel (1) made from quartz glass with two necks (1b, 1c) fitted diametrically to the envelope of the discharge bulb (1a), with a tungsten electrode (3) being fused in a gastight manner into each of the necks by a sealing foil (4a, 4b), with a fill including at least one noble gas, optionally metal halides (5) and optionally mercury, and a reflector (8) for collecting and focusing the light emitted from the discharge vessel (1), with holes for holding the discharge vessel (1) and for supply conductors (7) to pass through, and with a covering pane made from medium which is transparent to light, the space between the reflector (8) and the discharge vessel (1) is closed off in a gastight manner and filled with an inert gas or inert gas mixture.

### FIELD OF THE INVENTION

The invention is based on a reflector high-pressure discharge lamp, comprising a gastight discharge vessel made from quartz glass with two necks fitted diametrically to the envelope of the discharge bulb, with a tungsten electrode being fused in a gastight manner into each of said necks by means of a sealing foil, with a fill comprising at least one noble gas, optionally metal halides and optionally mercury, and a reflector for collecting and focusing the light emitted from the discharge vessel, with holes for holding the discharge vessel and for supply conductors to pass through, and with a covering pane made from medium which is transparent to light. In particular, the reflector high-pressure discharge lamp has a discharge vessel with short electrode-to-electrode distances, as are used for data projectors and rear-projection televisions or the like.

### BACKGROUND OF THE INVENTION

Operation of the abovementioned discharge lamps gives rise to very high temperatures. On the outside of the discharge space, the discharge vessel is heated up to approx. 1000° C. The temperature in the sealing sections of the discharge vessel is approx. 500° C. lower. The greater the distance from the discharge space, the lower the temperature becomes. The problem in this context is the part of the electrical supply conductors which is not fused in the glass and comes into contact with air. These supply conductors consist of molybdenum wire. However, molybdenum is corroded above a temperature of 400° C. The cause of the corrosion is the oxidation of the molybdenum with atmospheric oxygen. As a result, a relatively large number of lamps fail within their nominal service life. In particular necessary to make the seal section of the bulb necks relatively long (>20 mm). This lowers the temperature in the region of the molybdenum supply conductor wire but greatly restricts the lamp design.

The temperature of the molybdenum wire at the end of the sealing section of the discharge vessel drops at increasing distance from the discharge space. Therefore, the sealing section and the molybdenum foil can be lengthened in order to lower the temperature. This procedure is sufficient for low lamp powers (100-120 W). However, this is not true at higher lamp powers (200-250 W). In this case, active cooling is required, as can be achieved for example by an airflow, with the associated drawback of noise. For this purpose, slots are often externally milled into the reflector, in order to allow a direct air flow by means of forced cooling. In some cases, however, the reflector geometry does not permit longer discharge vessels. However, the temperature rises excessively if the discharge vessel is shortened. In this case, a slightly better thermal stability can be achieved with the aid of suitable coatings of the molybdenum, as disclosed for example by U.S. Pat. No. 5,387,840. As a result, the temperature in this region can be increased to 450° C. It is also possible to fit auxiliary means which allow targeted cooling of this region, such as for example a metal sheet (cf. for example U.S. Pat. No. 6,784,601), which is spot-welded to the molybdenum wire and is responsible for improved dissipation of heat.

### DISCLOSURE OF THE INVENTION

The object of the present invention is to provide a reflector high-pressure discharge lamp in which oxidation of the supply conductors is prevented.

In the reflector high-pressure discharge lamp, comprising a gastight discharge vessel made from quartz glass with two necks fitted diametrically to the envelope of the discharge bulb, with a tungsten electrode being fused in a gastight manner into each of said necks by means of a sealing foil, with a fill comprising at least one noble gas, optionally metal halides and optionally mercury, and a reflector for collecting and focusing the light emitted from the discharge vessel, with holes for holding the discharge vessel and for supply conductors to pass through, and with a covering pane made from medium which is transparent to light, this object is achieved by virtue of the fact that the space between the reflector and the discharge vessel is closed off in a gastight manner and filled with an inert gas or inert gas mixture.

The fill in the space between the reflector and the discharge vessel in this case consists of a gas which is resistant to high-voltage sparkovers, preferably pure nitrogen. In addition to nitrogen, the fill in the space between the reflector and discharge vessel may also consist of sulfur hexafluoride. Inert gas mixtures, the main constituents of which are nitrogen and/or sulfur hexafluoride and the secondary constituents of which are noble gases, are preferably also possible.

The filling pressure of the inert gas or inert gas mixture is preferably less than or equal to 1×10³ hPa.

The reflector in these reflector high-pressure discharge lamps consists of glass, glass-ceramic, ceramic or metal. The pane provided as a cover for the reflector is connected in a gas-tight manner to the reflector, in which case glass or an adhesive based on silicones, epoxy resins or bismaleimides may be provided as the seal.

To prevent the inert gas atmosphere in the space between the reflector and discharge lamp from escaping, furthermore, the holes in the reflector for holding the discharge vessel and for the supply conductors to pass through are closed off in an airtight manner using glass or an adhesive based on silicones, epoxy resins or bismaleimides.

In addition, a getter, which bonds possible oxidizing constituents in the gas phase to itself, may be arranged in the space between the reflector and the discharge vessel.

The invention allows the temperature in the region of the supply conductors to be increased as desired without oxidation occurring.

### BRIEF DESCRIPTION OF THE DRAWINGS

The invention is explained in more detail below on the basis of exemplary embodiments. In the drawings:

FIG. 1 shows a lateral section through a first exemplary embodiment of a reflector high-pressure discharge lamp according to the invention

FIG. 2 shows a lateral section through a second exemplary embodiment of a reflector high-pressure discharge lamp according to the invention

FIG. 3 shows a lateral section through a third exemplary embodiment of a reflector high-pressure discharge lamp according to the invention

FIG. 4 shows a lateral section through a fourth exemplary embodiment of a reflector high-pressure discharge lamp according to the invention.

### BEST MODE FOR CARRYING OUT THE INVENTION

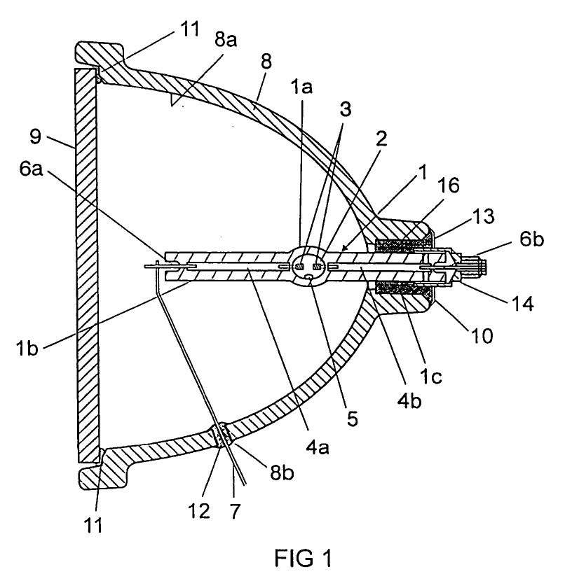

FIG. 1 shows a first exemplary embodiment of a reflector high-pressure discharge lamp. The reflector high-pressure discharge lamp is composed of a high-pressure gas discharge lamp 1 made from quartz glass and a reflector 8 made from glass with a reflective coating 8a. The reflector 8 is closed off on the side on which light emerges by means of a pane 9 of glass. The pane is adhesively bonded to the reflector 8 over the entire circumference by means of vacuum-tight adhesive 11 made from silicone. The region between reflector 8 and pane 9 is closed off in a gastight manner and filled with nitrogen with a cold filling pressure of 1×10³ hPa.

The high-pressure discharge lamp 1 is composed of the discharge bulb 1a and the two shanks 1b, 1c arranged diametrically on the discharge bulb 1a. The discharge vessel is arranged on the optical axis of the reflector 8 and has one shank 1c secured in a central hole 16 in the neck region of the reflector by means of a ceramic cement 10 based on silicate. The latter fills approximately 50% of the neck region. Behind this, the neck is closed off in a gastight manner by a vacuum-tight adhesive 13 made from silicone. Electrodes 3 made from tungsten are arranged diametrically opposite one another in the discharge space 2 of the bulb 1a. The electrodes 3 are fused into the shanks 1b, 1c of the discharge vessel 1 by means of sealing foils 4a, 4bmade from tungsten. Supply conductors 6a, 6bmade from molybdenum are welded to the outer ends of the sealing foils 4a, 4b, the free end of one supply conductor 6abeing connected to a further supply conductor 7 made from nickel wire, and the free end of the other supply conductor 6bin the region of the central bore 16 of the reflector 8 being directly connected to a cap 14.

The discharge space 2 of the discharge vessel 1 has a fill comprising mercury 5, metal halides and a noble gas mixture.

The further supply conductor 7 to the discharge vessel passes through a lateral hole 8b, which is closed off in a gastight manner by means of a vacuum-tight adhesive 12 made from silicone, with the supply conductor 7 also being adhesively bonded in place.

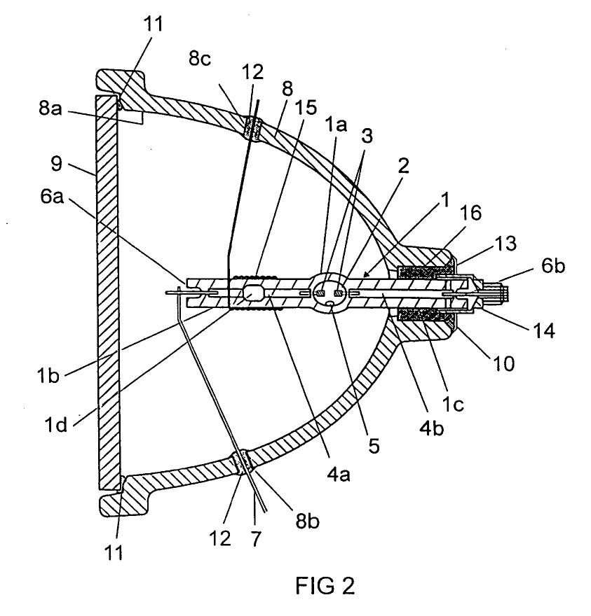

FIG. 2 shows a second exemplary embodiment of a reflector high-pressure discharge lamp and substantially corresponds to the reflector high-pressure discharge lamp shown in FIG. 1.

In this embodiment, however, the reflector 8 has lateral bores 8b, 8c. In the sealed region of the discharge vessel there is a bubble 1d, and a wire filament 15 is wound around the outside of this region of the shank 1b. This wire filament serves to reduce the required ignition voltage of the lamp. The wire filament 15 is passed through the second lateral reflector hole 8c, which is sealed off using silicone 12.

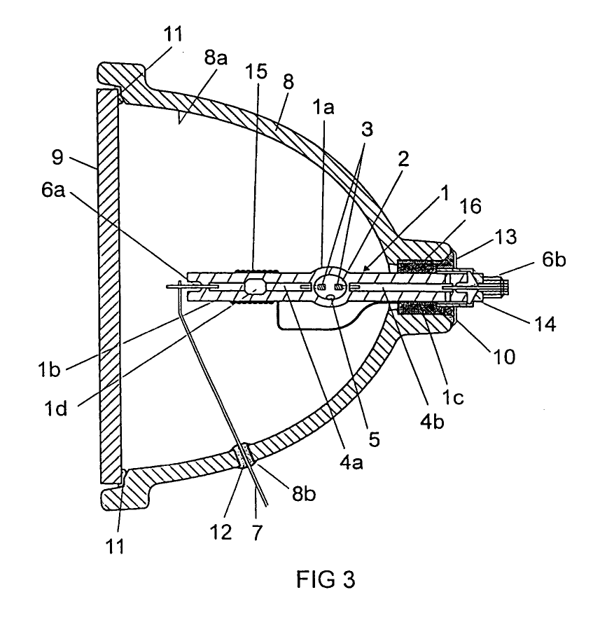

The reflector high-pressure discharge lamp shown in FIG. 3 differs from the reflector high-pressure discharge lamp unit shown in FIG. 2 by virtue of the fact that the wire filament 15 does not pass through a lateral hole, but rather through the reflector neck 16.

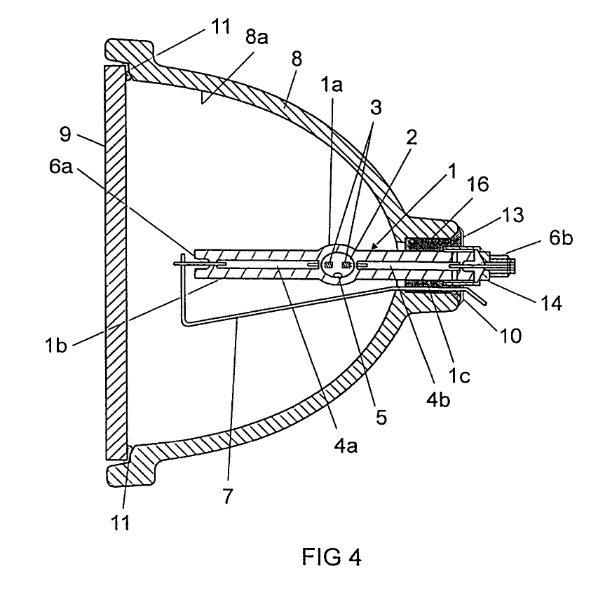

The reflector high-pressure discharge lamp shown in FIG. 4 corresponds to the unit shown in FIG. 1, except that it does not have a cap and does not have a lateral hole. The supply conductor for supplying current to the end of the discharge lamp 1 remote from the reflector neck in this case also passes through the neck region 16 of the reflector.

What is claimed is:

1. A reflector high-pressure discharge lamp, comprising
a gastight discharge vessel made from quartz glass with two necks fitted diametrically to the envelope of the discharge bulb, with a tungsten electrode being fused in a gastight manner into each of said necks by means of a sealing foil, with a fill comprising at least one noble gas, optionally metal halides and optionally mercury, and
a reflector for collecting and focusing the light emitted from the discharge vessel, with holes for holding the discharge vessel and for supply conductors to pass through, and with a covering pane made from medium which is transparent to light, wherein the space between the reflector and the discharge vessel is closed off in a gastight manner and filled with an inert gas or inert gas mixture.

2. The reflector high-pressure discharge lamp as claimed in claim 1, wherein the fill in the space between the reflector and the discharge vessel consists of pure nitrogen.

3. The reflector high-pressure discharge lamp as claimed in claim 1, wherein the fill in the space between the reflector and the discharge vessel consists of sulfur hexafluoride.

4. The reflector high-pressure discharge lamp as claimed in claim 1, wherein the fill in the space between the reflector and the discharge vessel consists of an inert gas mixture, the main constituents of which are nitrogen and/or sulfur hexafluoride and the auxiliary constituents of which are noble gases.

5. The reflector high-pressure discharge lamp as claimed in claim 1, wherein the filling pressure of the inert gas or inert gas mixture is less than or equal to 1×10³ hPa.

6. The reflector high-pressure discharge lamp as claimed in claim 1, wherein the reflector consists of glass, glass-ceramic, ceramic or metal.

7. The reflector high-pressure discharge lamp as claimed in claim 1, wherein the gap between the pane and the reflector is filled with glass in an airtight manner.

8. The reflector high-pressure discharge lamp as claimed in claim 1, wherein the pane is adhesively bonded to the reflector in an airtight manner using an adhesive based on silicones, epoxy resins or bismaleimides.

9. The reflector high-pressure discharge lamp as claimed in claim 1, wherein the reflector holes are closed off in an airtight manner using glass or an adhesive based on silicones, epoxy resins or bismaleimides.

10. The reflector high-pressure discharge lamp as claimed in claim 1, wherein a getter, which bonds possible oxidizing constituents in the gas phase to itself, is arranged in the space between the reflector and the discharge vessel.
